(19) United States
(12) Patent Application Publication
(10) Pub. No.: US 2006/0155772 A1
(43) Pub. Date: Jul. 13, 2006

(54) Data processor controlled interactive document editing display system with an implementation for transferring a block of displayable data from a source to a target document without displaying the target document

(76) Inventors: Howard Neil Anglin, Austin, TX (US); Wen Wendy Hsu, Austin, TX (US); Frank Anthony Nuzzi, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/032,263

(22) Filed: Jan. 10, 2005

(51) Int. Cl. G06F 17/30

(52) U.S. Cl. 707/200

(57) ABSTRACT

There may be circumstances under which the user may wish the convenience of being able to insert a textual block into the file of a particular document without having to open the file of the receiving document and displaying the receiving document. Indicating a block of data in a displayed document to be copied to another selected document in combination with locating the data file of this selected target document and then copying the indicated block of data into the file of the selected target document without displaying this target document during the copying. Since the target document file is not opened so that the target document may be displayed, it is preferable that a position in the file of the target document be preselected and the textual data block being transferred placed at that preselected position.

### TECHNICAL FIELD

The present invention relates to user interactive computer supported display technology and particularly to such user interactive text processing and text based systems including hypertext systems, such as the Internet's hypertext markup language (HTML) and extended markup language (XML) that are user friendly and provide interactive users with a display interface environment that is easy to use.

### BACKGROUND OF RELATED ART

The past generation has been marked by a technological revolution driven by the convergence of the data processing industry with the consumer electronics industry. This advance has been even further accelerated by the extensive consumer and business involvement in the Internet over the past few years. The effect has, in turn, driven technologies that have been known and available but relatively quiescent over the years. A major one of these technologies is the Internet or Web. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of databases providing documents, media and computer programs through related distribution of Web documents, e.g. Web pages or electronic mail. Because of the ease with which documents are distributable via the Web, it has become a major source of data. Virtually all databases of public information throughout the world are accessible and able to be searched via the Web.

The ease with which great volumes of data may be searched from a computer attached to the Internet and equipped with a Web browser has led to the development of widespread electronic commerce over the Web. At the present time, it is becoming very rare to find a business organization of any kind that does not transact some aspect of the business via the Web. Also, as a result of these changes, it seems as if virtually all aspects of human endeavor in the industrialized world requires human-computer interfaces.

One area where the computer controlled technology has made a tremendous advance in productivity: word or text processing, where reliable textual output has been increased ten-fold. These text processing or text based systems, of course, include Hypertext systems such as HTML and XML that are at the heart of Internet or Web based transfers of displayable data. However, the word processing technology continues to seek new expedients that are user friendly to further enhance the speed and reliability of this technology. The present invention relates to the transfer of displayable data, and provides an expedient to enhance this technology. Conventionally, the transfer of blocks of displayable textual data from a source document to a target or receiving document requires that the file of the receiving document be opened so that the receiving document may be displayed, and then transferred, e.g. moved or copied text may be inserted into the receiving document.

### SUMMARY OF THE PRESENT INVENTION

The present invention involves the recognition that there may be circumstances under which the user may wish the convenience of being able to insert a textual block into the file of a particular document without having to open the file of the receiving document, and displaying the receiving document. For example, when a particular block of textual data in a source document is to be transferred into several receiving or target documents. In such a case, the block of data may be defined in the source document as will be hereinafter described, and then transferred directly to the files of several target documents sequentially without opening and displaying each of the individual target documents.

The invention involves means for indicating a block of data in a displayed document to be copied to another selected document in combination with means for locating the data file of this selected target document, and means for then copying the indicated block of data into the file of the selected target document without displaying this target document during the copying.

Since the target document file is not opened so that the target document may be displayed, it is preferable that a position in the file of the target document be preselected and the textual data block being transferred placed at that preselected position. The preselected position may conveniently be the first or the last sequential storage position in the file of the target document. As set forth above, in accordance with this invention, the means for copying the indicated block of data copies this indicated block to a plurality of files of selected documents without displaying said selected documents during said copying. On the other hand, this invention may conveniently be used for copying such indicated blocks of data from a plurality of displayed documents into the file of one selected or target document without displaying said selected document during the copying.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the computer controlled systems on which the present invention may be implemented, as well as source Web stations from which the requested Web document data blocks may be sent and target Web stations to which the requested document data blocks may be sent; the system may be used for all of the other computers used in the present invention, including conventional servers used throughout the Web for Web Servers supporting the user or client terminals;

FIG. 2 is a generalized diagrammatic view of a Web portion upon which the present invention may be implemented;

FIG. 3 is a diagrammatic display interface showing how a block of data in an opened and displayed Web document may be defined for transferring to a target document;

FIG. 4 is a simplified diagrammatic broken-away section of a display interface showing the mechanism for transferring to the target document; shown are selectable folders that would contain the target document;

FIG. 5 is a simplified diagrammatic broken-away section of a display interface showing the mechanism for transferring to the target document the file that is selected from the document files in the selected folder of FIG. 4;

FIG. 6 is a general flowchart of a program set up to implement the present invention for transferring a block of displayable data from one displayable document to another without displaying the receiving document; and

FIG. 7 is a flowchart of an illustrative run of a program set up in accordance with the flowchart of FIG. 6.

### DETAILED DESCRIPTION OF THE PREFERRED EMBODIMENT

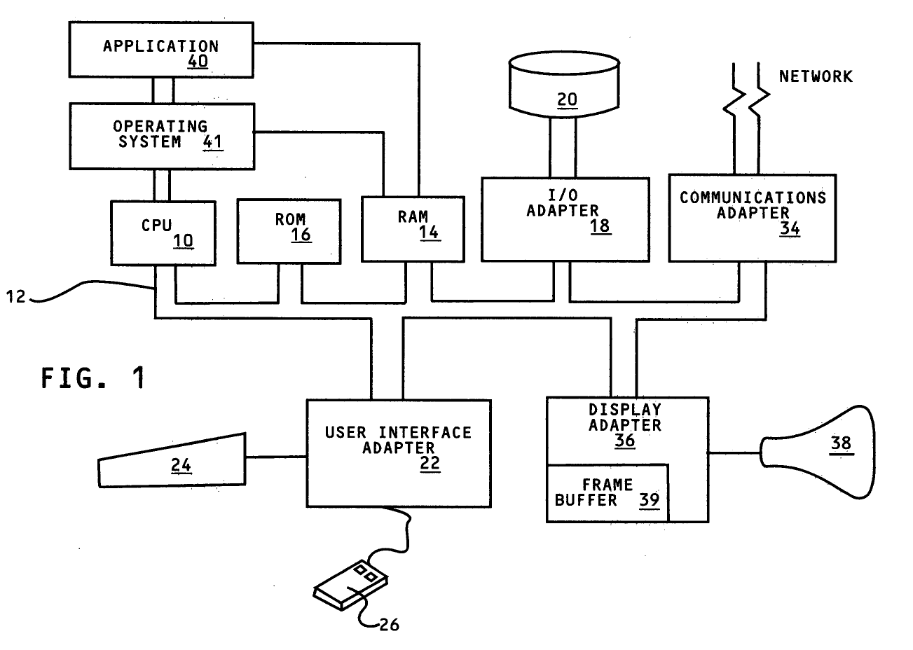

Referring to FIG. 1, a typical data processing terminal is shown that may function as the receiving display terminal containing data processing implementation involved in the present invention of transferring a block of displayable data from one displayable document to another without opening or displaying the receiving document. Also, where the transfer is between documents over a network, such as the Web or Internet (used interchangeably herein), then the system may also be used for other standard servers used throughout the Web.

In FIG. 1, a central processing unit (CPU) 10, such as one of the PC microprocessors or workstations, e.g. RISC System/6000™ series available from International Business Machines Corporation (IBM) or Intel microprocessors, is provided and interconnected to various other components by system bus 12. An operating system 41 runs on CPU 10, provides control and is used to coordinate the function of the various components of FIG. 1. Operating system 41 may be one of the commercially available operating systems, such as Microsoft's WindowsXP™ or Windows2000™, as well as IBM AIX and other UNIX operating systems. Application programs 40, controlled by the system, are moved into and out of the main memory Random Access Memory (RAM) 14. These programming applications include all of the programming to be subsequently described for transferring a block of displayable data from one displayable document to another without opening or displaying the receiving document. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Web or like network as appropriate. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through keyboard 24 or mouse 26 and receiving output information from the system via display 38.

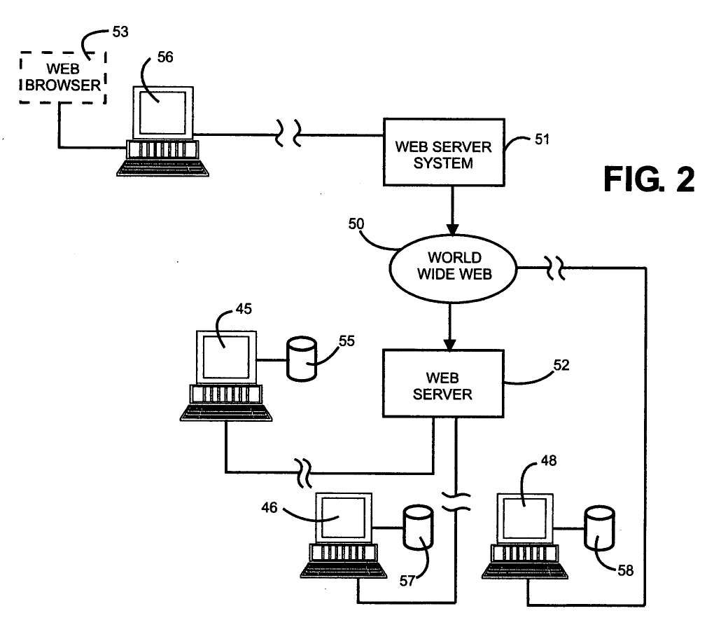

A generalized example of the practice of the present invention involving the transfer of blocks of displayable data will be considered with respect to FIG. 2 that shows a generalized portion of the Web. First, it should be helpful to understand from a more general perspective the various elements and methods that may be related to the present invention. Since the present invention involves Web hypertext documents, the textual content of which will be transferred in blocks over networks, an understanding of the Internet or Web and its operating principles would be helpful. Reference has also been made to the applicability of the present invention to a global network, such as the Internet or Web. For details on Internet nodes, objects and links, reference is made to text, Mastering the Internet, G. H. Cady et al., published by Sybex Inc., Alameda, Calif., 1996. (Web and Internet are used interchangeably in this description.)

The Internet or Web is a global network of a heterogeneous mix of computer technologies and operating systems. Higher level objects are linked to lower level objects in the hierarchy through a variety of network server computers. These network servers are the key to network distribution, such as the distribution of Web pages and related documentation.

Web documents are conventionally implemented in HTML language, which is described in detail in the text, Just Java, 2nd Edition, Peter van der Linden, Sun Microsystems, 1997, particularly at Chapter 7, pp. 249-268, dealing with the handling of Web pages; and also in the text, Mastering the Internet, particularly at pp. 637-642, on HTML in the formation of Web pages. In addition, aspects of this description will refer to Web browsers. A general and comprehensive description of browsers may be found in the above-mentioned Mastering the Internet text at pp. 291-313. More detailed browser descriptions may be found in the text, Internet: The Complete Reference, Millennium Edition, M. L. Young et al., Osborne/McGraw-Hill, Berkeley Calif., 1999, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

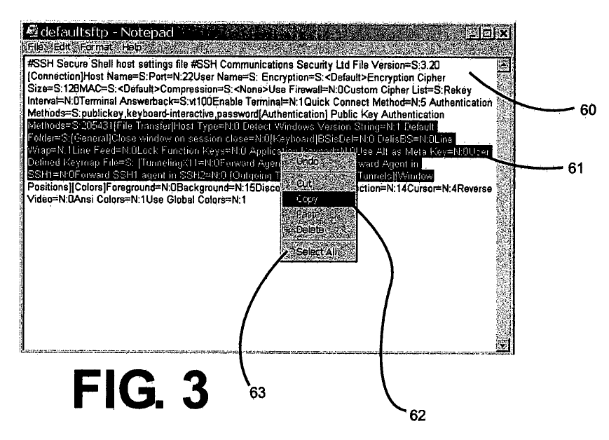

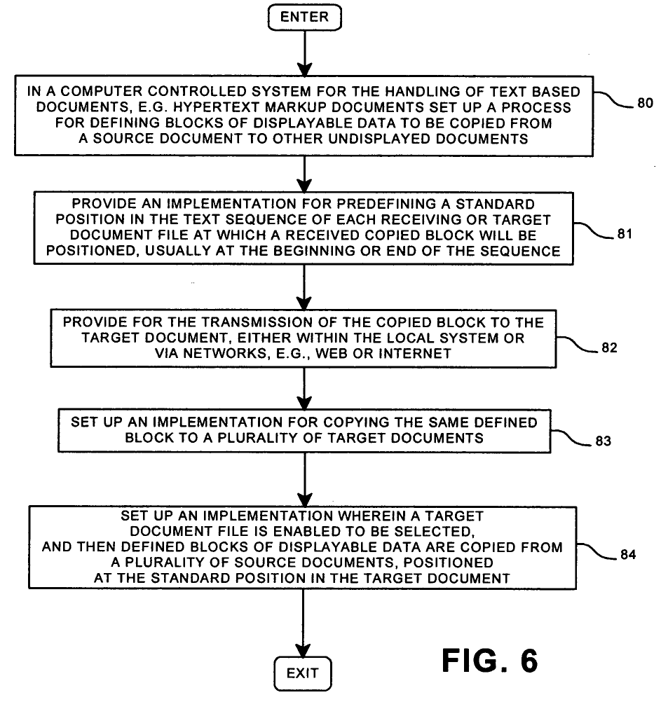

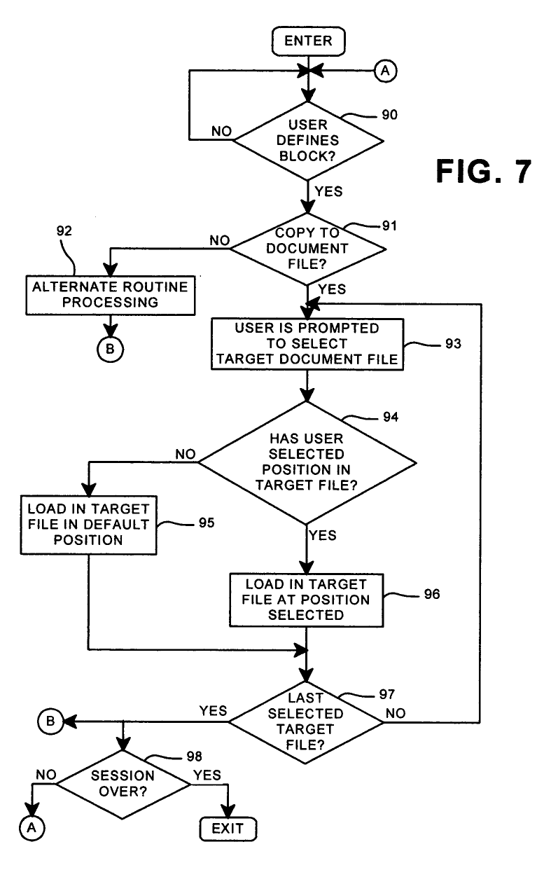

Within this environment, Web Services distribution has evolved in recent years. Web Services are based on both suppliers of the data in the form of XML based messages and documents and applications consuming such data conforming to several industry standards developed by the W3C. The primary standard is XML for defining data and creating markup languages in the form of XML tags. The resulting XML documents are text based and, thus, may be processed on any platform in the distribution of the Web Services. In light of this background, reference is made to FIG. 2 showing a portion of the Web or Internet set up for the distribution of text based data. Thus, blocks of textual data from HTML or XML documents may be transmitted over the Web and entered into receiving or target Web documents without opening or displaying such target documents in accordance with the present invention. For purposes of the present embodiment, let computer station 56 serve as a typical Web display station for receiving or sending Web documents. As will be described hereinafter with respect to the display interfaces of FIGS. 3 through 5, and the program of FIGS. 6 and 7, the Web documents sending the blocks of text are displayed on computer display station 56, and the blocks of textual data are defined therein. Then, under the control of any conventional Web browser in computer 56, the defined textual data blocks are sent through a conventional Web server system 51, via the Web 50 to any document files respectively in any of databases 55, 57 and 58 respectively associated with Web display stations 45, 46 and 48. As will be described in further detail with respect to FIGS. 3 through 5, the files of the documents into which the textual data blocks are transferred are not opened and the receiving documents are not displayed. It will be understood that a block of defined displayable textual data taken from computer system 56 may be transferred to multiple document files in databases 56, 57 and 58 without opening the respective receiving document files.

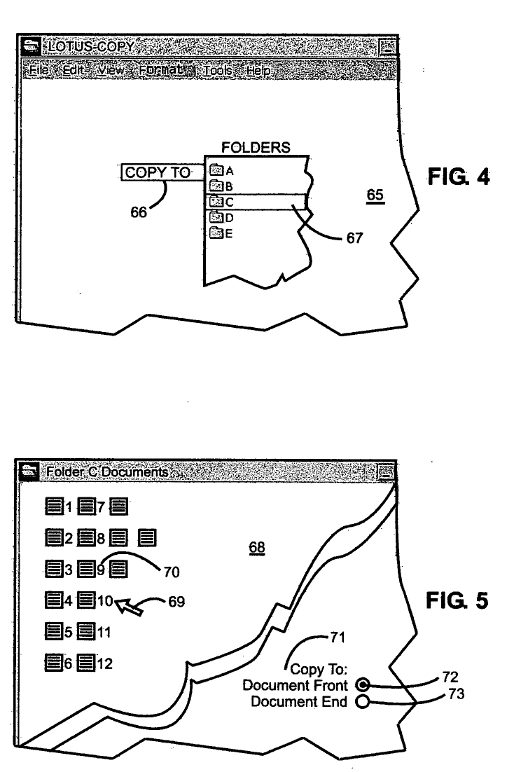

With reference to FIG. 3, the display screen 60, as shown, has a displayed text document at the stage where a block of text 61 has been blocked off in any standard display interface manner, e.g. mouse directed cursor or pointer. Under the direction of a mouse, a menu 63 has been opened from which the user has selected “copy” 62. As a result, the block of text 61 will be sent. Clicking on “copy” 62 then brings up the dialog screen 65 in FIG. 4 wherein the user is prompted 66 to select an appropriate folder 67 that should contain the document file to which the block is to be copied. In this example, the user has selected folder “C”, which, in turn, brings up display screen 68, FIG. 5, that displays a plurality of document icons 70, each representing a document file in folder “C”. By moving and clicking with pointer 69, the user may select one or more of the target document files into which the defined block of displayed data from FIG. 3 is to be transferred. These multiple document files need not all be in folder “C”. The files may be in several different folders in different databases on the Web.

As will subsequently be described in greater detail with respect to the programs of FIGS. 6 and 7, the transferred block of data is entered into each document file at a predetermined position that is, preferably, at the front or at the end of the sequential data in each document file. It is important to note that each target document file is not opened and the target document, thus, need not be displayed. As a result, the data blocks are quickly and effectively transferred. If the target document is an unstructured document, further repositioning of the transferred data block may be unnecessary. In the case of structured target documents, the user may eventually wish to reposition the received block of textual data within the structure of the document.

Now, with reference to FIGS. 6 and 7, we will describe a process implemented by the present invention in conjunction with the flowcharts of these figures. FIG. 6 is a flowchart showing the development of a process according to the present invention for transferring a block of displayable data from one displayable document to another without displaying the receiving document. In a computer controlled system for the handling of text based documents, there is set up a process for defining blocks of displayable data to be copied or otherwise transferred from a source document to other documents that need not be displayed, step 80. An implementation is provided for predefining a default or standard position in the text sequence of each target document file at which a received text block may be positioned. This is usually at the beginning or end of the sequence, step 81. Provision is made for the transmission of the copied block to the target document, either within a local system or through networking, e.g. the Internet or Web, step 82. An implementation is also set up for copying the same defined block into a plurality of target documents, step 83. There is also set up an implementation wherein a target document file is enabled to be selected, and then defined blocks of displayable text are copied from a plurality of source documents and positioned at the standard position in the target document, step 84.

An illustrative run of the process set up in FIG. 6 will now be described with respect to FIG. 7. First, step 90, a determination is made as to whether a user at a source of a document block to be transferred has defined a block. If No, such a definition is awaited. If Yes, a further determination is made, step 91, as to whether a user has selected to copy the block to a document file in accordance with the present invention without opening and displaying the document. If No, then as indicated by step 92, the document is handled by routine document processing as an alternative. If step 91 is Yes, then the user is prompted to select a target document file, step 93, after which a determination is made as to whether the user has selected a position in the document file at which the transferred block of data is to be placed, step 94. If Yes, then the block of text data is loaded into the target document file at the user selected position, step 96. If No, then the block of text data is loaded into the document file at the preselected or default position, step 95. At this point a determination is made, step 97, as to whether this is the last selected target document file in which the block of text data is to be entered. If No, the process is branched back to step 93. If Yes, and also after routine step 92 via branch “B”, a further determination is made as to whether the session is over, step 98. If Yes, the process is exited. If No, the process is branched back to initial step 90 via branch “A”.

One of the implementations of the present invention is as an application program 40 made up of programming steps or instructions resident in RAM 14, FIG. 1, during computer operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled system for displaying text based documents including a plurality of displayable documents, each document being stored as a data file, a system for transferring a block of displayable data from one displayable document to another comprising:
means for indicating a block of data in a displayed document to be copied to another selected document;
means for locating the data file of said selected document; and
means for copying said indicated block of data into the file of the selected document without displaying said selected document during said copying.

2. The system for transferring a block of displayable data of claim 1 further including means for selecting a position in the data file of the selected document at which all copied data is to be placed.

3. The system for transferring a block of displayable data of claim 1 wherein said position in the data file of the selected document is to be copied is the first sequential storage position in said file.

4. The system for transferring a block of displayable data of claim 1 wherein said position in the data file of the selected document is to be copied is the last sequential storage position in said file.

5. The system for transferring a block of displayable data of claim 1 further including means for copying said indicated blocks of data from a plurality of displayed documents into the file of the selected document without displaying said selected document during said copying.

6. The system for transferring a block of displayable data of claim 1 wherein said means for copying said indicated block of data copies said indicated block to a plurality of files of selected documents without displaying said selected documents during said copying.

7. The computer controlled system of claim 1 wherein:
said transfer of displayable data is to data files maintained at network display stations in a computer network; and
the text based documents are hypertext markup language documents.

8. In a computer controlled system for displaying text based documents including a plurality of displayable documents, each document being stored as a data file, a method for transferring a block of displayable data from one displayable document to another comprising:
indicating a block of data in a displayed document to be copied to another selected document;
locating the data file of said selected document; and
copying said indicated block of data into the file of the selected document without displaying said selected document during said copying.

9. The method for transferring a block of displayable data of claim 9 further including the step of selecting a position in the data file of the selected document at which all copied data is to be placed.

10. The method for transferring a block of displayable data of claim 9 wherein said position in the data file of the selected document is to be copied is the first sequential storage position in said file.

11. The method for transferring a block of displayable data of claim 9 wherein said position in the data file of the selected document is to be copied is the last sequential storage position in said file.

12. The method for transferring a block of displayable data of claim 9 further including steps of copying said indicated blocks of data from a plurality of displayed documents into the file of the selected document without displaying said selected document during said copying.

13. The method for transferring a block of displayable data of claim 9 wherein said step of copying said indicated block of data copies said indicated block to a plurality of files of selected documents without displaying said selected documents during said copying.

14. The method of claim 9 wherein:
said transfer of displayable data is to data files maintained at network display stations in a computer network; and
the text based documents are hypertext markup language documents.

15. In a computer controlled system for displaying text based documents including a plurality of displayable documents, each document being stored as a data file, a computer program having code recorded on a computer readable medium for transferring a block of displayable data from one displayable document to another comprising:
means for indicating a block of data in a displayed document to be copied to another selected document;
means for locating the data file of said selected document; and
means for copying said indicated block of data into the file of the selected document without displaying said selected document during said copying.

16. The computer program for transferring a block of displayable data of claim 17 further including means for selecting a position in the data file of the selected document at which all copied data is to be placed.

17. The computer program for transferring a block of displayable data of claim 17 wherein said position in the data file of the selected document is to be copied is the first sequential storage position in said file.

18. The computer program for transferring a block of displayable data of claim 17 wherein said position in the data file of the selected document is to be copied is the last sequential storage position in said file.

19. The computer program for transferring a block of displayable data of claim 17 further including means for copying said indicated blocks of data from a plurality of displayed documents into the file of the selected document without displaying said selected document during said copying.

20. The computer program for transferring a block of displayable data of claim 17 wherein said means for copying said indicated block of data copies said indicated block to a plurality of files of selected documents without displaying said selected documents during said copying.
